(19) United States
(12) Patent Application Publication
(10) Pub. No.: US 2015/0127357 A1
(43) Pub. Date: May 7, 2015

(54) Interactive Behavior of Corporate Parents and Managed Care Organizations

(71) Applicant: IMS Health Incorporated, Danbury, CT (US)

(72) Inventors: Yilian Yuan, North Wales, PA (US); Lingyun Su, Philadelphia, PA (US)

(21) Appl. No.: 14/069,716

(22) Filed: Nov. 1, 2013

(51) Int. Cl. G06Q 30/02; G06Q 50/22

(52) U.S. Cl. CPC G06Q 30/0201; G06Q 50/22
USPC 705/2

(57) ABSTRACT

The disclosure generally describes computer-implemented methods, software, and systems for measuring and quantifying the interactive effect of corporate parents and managed care organizations on pharmaceutical product performance. The disclosure relates to implementations that facilitate the accessing of information from actors within a health care system and processing the information by an analytical infrastructure.

### BACKGROUND

A corporate parent is a legal entity that owns, manages, leases or affiliates purely for purchasing care providing entities including medical group practice, clinics and hospitals. Managed care organizations (MCOs) are governed by a set of guidelines and regulations that control tier structure and co-pay benefits designs. Both corporate parents and MCOs influence prescribing behavior.

### OVERVIEW

The present disclosure relates to computer-implemented methods, software, and systems for measuring and quantifying the interactive effect of corporate parents and managed care organizations on pharmaceutical product performance. The disclosure relates to implementations that facilitate the accessing of information from actors within a health care system and processing the information by an analytical infrastructure.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of an analytical infrastructure system implemented in a computing system 100.

FIG. 2 illustrates the various actors involved in affecting the prescribing behavior of a physician.

FIG. 3 illustrates the interactions of one or more managed care plans and corporate parents.

FIGS. 4 and 5 illustrate example graphical representations of market share concentration among corporate parents.

FIG. 6 is a flow chart of a process by which an analytical infrastructure uses accessed market sales data to generate a model for the interaction between the corporate parent organization and managed care organization.

FIGS. 7 and 8 illustrate example user interfaces for user interaction with a webpage application of a sales management tool.

### DETAILED DESCRIPTION

This disclosure generally describes computer-implemented methods, software, and systems for measuring and quantifying the interactive effect of corporate parents and managed care organizations (MCOs) on pharmaceutical product performance, using an analytical and reporting infrastructure.

The operation described below describes the interactive influences of corporate parents and managed care organizations on retail prescribing behavior. The prescribing behavior of a physician has been influenced by of various stake holders in the past, such as payers, patients, pharmaceutical companies, prescribers, corporate parents and managed care organizations. There have been several changes to the healthcare environment and new stake holders have had an increasingly large effect of the selection of prescription choice, more so than, the physician prescribing the drug. In particular there has been a significant increase in the presence of the influence from corporate parents on prescriber behavior. A corporate parent is a legal entity that owns, manages, leases, or affiliates purely for purchasing care providing entities, including medical group practices, clinics, and hospitals. An integrated delivery network (IDN) is special type of corporate parent.

Corporate parents may have treatment guidelines and protocols that must be upheld by physicians within the network and therefore, by the nature of the corporate parent structure, prescription choice is influenced by corporate parent presence. Corporate parents often require evidence of drug therapeutic effectiveness and costly effectiveness is also very important to the successful performance of a corporate parent. Corporate parents may even restrict pharmaceutical companies' sale representatives from promoting products to members of the corporate parent. The number of corporate parents and the influence of corporate parents are also on the rise and the influence of corporate parents is expected to increase under the Patient Protection and Affordable Care Act (PPACA), commonly called the Affordable Care Act (ACA) or “Obamacare.” Managed care are governed by a set of guidelines and regulations that control tier structure and co-pay benefits designs that may influence the prescribing behavior of physicians that are influenced by the MCO. The analytical framework may measure the relative influence of managed care organizations and corporate parents on physician prescribing behavior.

The operation described herein allows a user to understand the influence of the managed care organizations and corporate parents on prescribing behavior. The user may use an analytical infrastructure to determine and understand the interactive behavior between the corporate parent and the MCO and based on the interactive behavior, developing marketing strategies. The user may be a sales representative at a pharmaceutical company. In some implementations, the analytical infrastructure may be used for allocating commercial resources across the sales, marketing and managed markets strategies on a geographical granular level. The analytical framework developed may be implemented on a webpage and used by pharmaceutical companies to generate and manage marketing resources for example, time, staffing and budgets. These marketing tactics may include coordinating sales representative calls to physicians, providing free drug samples to physicians' offices, grass roots (direct-to-consumer marketing) campaigns for new drugs, physician conferences, support for managed care contract designs with drug copays, and rebates offered to payers to cover a specific drug.

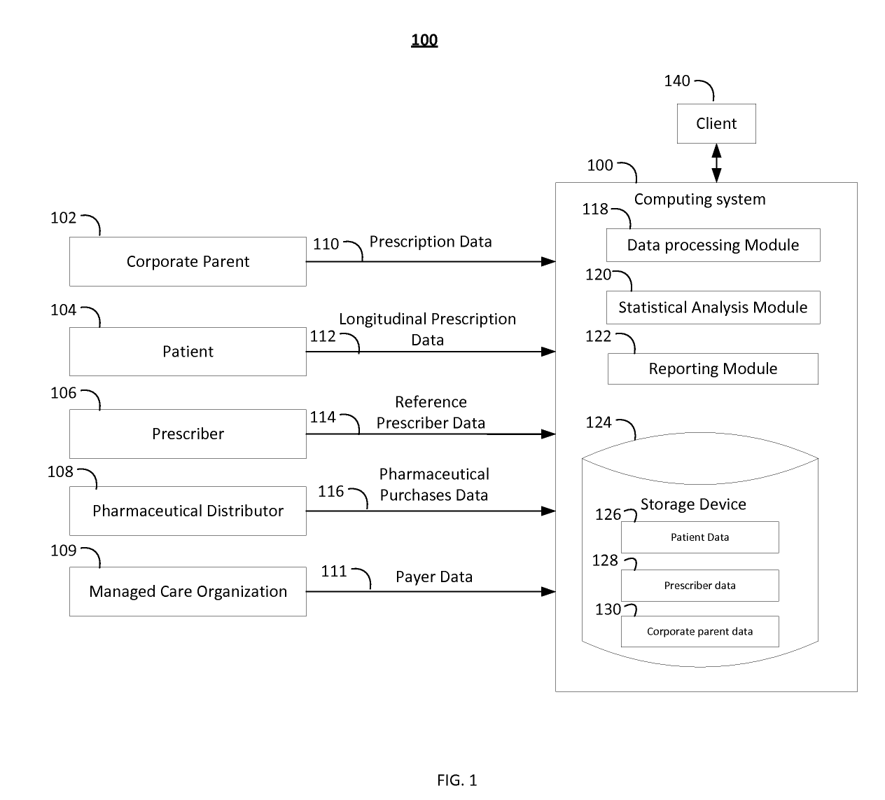

FIG. 1 illustrates an example analytical infrastructure system implemented in a computing system 100. The computing system may be implemented as a data processing apparatus that is capable of providing the functionality discussed herein, and may include any appropriate combination of processors, memory, and other hardware and software that can receive appropriate medical data and process the data as discussed below. At a high-level, the illustrated example computing system 100 receives various data from sources that are participants in the healthcare process. The sources may include corporate parents 102, patient system 104, prescriber system 106, pharmaceutical distributors 108, and managed care organization system 109. The data may include physician prescription data 110, longitudinal patient data 112, reference prescriber data 114, pharmaceutical purchase data 116, and payers prescription data. The data may further include IMS Rx data, including market decile and share of market data.

FIG. 1 illustrates the process by which an analytical infrastructure is able to integrate prescription choice data, for example, from patient system 104 or from prescriber system 106, with other data sources available in IMS, such as corporate parents 102, pharmaceutical distributors 108, and payer system 109. The data from patient system 104 is not restricted to longitudinal patient data 112 but may include any data from a health care provider or the prescriber system 106. The data may include prescription information related to the patient, for example the recent prescriptions written to the patient and whether or not the prescription drug was covered by the patient's payer or insurance company. It is important to understand that the system may be configured to preserve patient privacy, and will not store nominative data in an aggregated database but only de-identified data. Nominative data for an individual can be compared to the relevant aggregated data, but this may be achieved by using aggregated values in the individual patient application, not by keeping nominative records for multiple patients in a single database. Also, the integration of data from sources other than the user and their medical professionals may be achieved on a de-identified basis except in the instance that the individual gives permission to use their identity information (name, location, gender and age) for the purpose of providing them with their information from another source, such as pharmaceutical purchase data 116 from pharmacies.

The physician prescription data 110 may include data regarding prescriptions prescribed by physicians under a corporate parent. The prescription data 110 may be received directly from one or more corporate parents and represent data reflecting all prescriptions for pharmaceutical products issued by physicians within the one or more corporate parents 102, including information about the type of prescription used to obtain the product and the payment method used to purchase the product. As noted previously, this information may be sanitized and aggregated to protect patient privacy. The prescription data may include the total revenue spent on prescriptions based on the specific drug. In some implementations, the data may be based on the total revenue spent on a specific drug in a specific geographic location. The one or more corporate parents may provide the retail prescription data 110 on a periodic basis (e.g., every week or month). Though FIG. 1 shows the prescription data 110 being provided directly from the one or more corporate parents 102 to the computing system 100, the prescription data 110 may be collected by one or more other intermediate systems and then provided to the computing system 100. If intermediate systems are used, the aggregation and sanitization of the retail prescription data 110 may potentially be performed by the intermediate systems.

The longitudinal patient data 112 may include sanitized retail patient-level data for the one or more patient systems 104. For example, the longitudinal patient data 112 may include information about retail pharmacy-sourced prescription insurance claims, retail pharmaceutical scripts, and/or patient profile data. Longitudinal patient data 112 includes information about aspects of care for the one or more patient systems 104. Though FIG. 1 illustrates the longitudinal patient data 112 as being received by the computing system 100 directly from one or more patient systems 104, the longitudinal patient data 112 may be collected by one or more other systems and then provided to the computing system 100 in a manner analogous to the similar approach discussed for retail prescription data 110. Moreover, the longitudinal patient data 112 may not originate from the one or more patient systems 104, but may rather be provided by one or more prescribers/physicians with whom patient interacts, insurance companies to which a patient submits insurance claims, and/or retailers at which a patient purchases a pharmaceutical product.

The reference prescriber data 114 may include background information for one or more prescribers 106. For example, the reference prescriber data 114 may include a prescriber's demographic information, address, affiliations, authorization data (e.g., DEA, AOA, SLN, and/or NPI numbers), profession, and/or specialty. While most prescribers will be medical doctors, other healthcare professionals such as physician-assistants or nurse practitioners may also be prescriber systems 106. Though FIG. 1 illustrates the reference prescriber data 114 as being received by the computing system 100 directly from one or more prescriber systems 106, the reference prescriber data 114 may be collected by one or more other systems and then provided to the computing system 100 in a manner analogous to the similar approach discussed for retail prescription data 110. Moreover, the reference prescriber data 114 may not originate from the one or more prescriber systems 106, but rather be created and/or maintained by one or more other entities (e.g., government agencies or professional medical organizations) that track information about the prescribing behavior of prescribers 106.

The pharmaceutical purchase data 116 may include information about pharmaceutical purchases made from distributors 108 (e.g., pharmaceutical wholesalers or manufacturers). For example, the pharmaceutical purchase data 116 may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. Though FIG. 1 illustrates the pharmaceutical purchase data 116 as being received by the computing system 100 directly from one or more distributors 108, the pharmaceutical purchase data 116 may be collected by one or more other systems and then provided to the computing system 100 in a manner analogous to the similar approach discussed for retail prescription data 110. Moreover, the pharmaceutical purchase data 116 may not originate from the one or more distributors 108, but rather be provided by the purchaser of the pharmaceutical product (e.g., a retail outlet).

The payer data 111 may include information about the managed care organization influencing the one or more prescribers or one or more patients that data is collected. The payer data may include the tier structure of the one or more managed care organizations and further may include the co-pay benefits associated with the different levels of the tier structures of the one or more managed care organizations. The payer information may also include data about the insurance companies covering the cost of prescriptions. A payer may be the insurance company that covers a patient, or in the case where the patient does not have insurance, and is covered by Medicaid the payer may be the government. For example, the payer data 111 may include information about how much of a prescription's cost was covered by the insurance company or by Medicaid. Though FIG. 1 illustrates the payer data 111 as being received by the computing system 100 directly from one or more payer system 109, the payer data 111 may be collected by one or more other systems and then provided to the computing system 100.

The various types of data just discussed, which may include prescription data 110, longitudinal prescription data 112, reference prescriber data 114, pharmaceutical purchases data 116, and payer data 111, are received by computing system 100 in order to derive conclusions based on the data. As noted previously, by the time the data is received by computing system 100, it should have been sanitized so that the data does not include private or confidential information that computing system 100 should not able to access.

For illustrative purposes, computing system 100 will be described as including a data processing module 118, a statistical analysis module 120, a reporting module 122, and a storage device 124. However, the computing system 100 may be any computing platform capable of performing the described functions. The computing system 100 may include one or more servers that may include hardware, software, or a combination of both for performing the described functions. Moreover, the data processing module 118, the statistical analysis module 120, and the reporting module 122 may be implemented together or separately in hardware and/or software. Though the data processing module 118, the statistical analysis module 120, and the reporting module 122 will be described as each carrying out certain functionality, the described functionality of each of these modules may be performed by one or more other modules in conjunction with or in place of the described module.

The data processing module 118 receives and processes one or more of prescription data 110, longitudinal patient data 112, reference prescriber data 114, pharmaceutical purchase data 116, and payer data 111. In processing the received data, the data processing module 118 may filter and/or mine the prescription data 110, longitudinal patient data 112, reference prescriber data 114, pharmaceutical purchase data 116, and payer data 111 for specific information. The data processing module 118 may filter and/or mine the received retail prescription data 110, longitudinal patient data 112, reference prescriber data 114, pharmaceutical purchase data 116, and payer data 111 for specific pharmaceuticals products. Thus, any received retail prescription data 110, longitudinal patient data 112, reference prescriber data 114, pharmaceutical purchase data 116, and payer data 111 that regards pharmaceutical products that are not classified as being associated with a tracked compound or prescription may be disregarded. For example, the received data may be processed by data processing module 118 so as to track use of a specific antibiotic, or of antibiotics in general.

After processing the received prescription data 110, longitudinal patient data 112, reference prescriber data 114, pharmaceutical purchase data 116, and payer data 111, the data processing module 118 aggregates the processed data into patient data 126, prescriber data 128, and corporate data 130. These groups of data may be stored in storage device 124. In some implementations, the data processing module 118 may create profiles for each patient, prescriber, corporate parent and managed care organization for which data is received.

Prescription data 110 may include prescription information from prescriptions prescribed by a physician, information about one or more patients that were prescribed pharmaceutical products, and information about one or more prescribers under a corporate parent and the managed care organization that influences the prescriber. In this example, data processing module 118 would add information contained in the received prescription data 110 into profiles associated with the one or more corporate parents, the one or more managed care organizations, the one or more patients, and the one or more prescribers. In another example, longitudinal patient data 112 may include information about a patient that received prescriptions for a pharmaceutical product and information about one or more prescribers from which the patient received the prescriptions. In this example, data processing module 118 would add information contained in the received longitudinal patient data 112 into profiles associated with the patient and the one or more prescribers.

In other implementations, the data processing module 118 may simply sort and store, in storage device 124, processed prescription data 110, longitudinal patient data 112, reference prescriber data 114, pharmaceutical purchase data 116 and payer data 111, the data processing module 118 for later use by other modules.

For each patient system 104, the patient data 126 may include any information related to the prescription and/or sale of one or more types of pharmaceutical products. Patient data 126 may include the quantity of each type of pharmaceutical product the patient has purchased, cumulative days' supply of a pharmaceutical product the patient should still have, cumulative dosage of a pharmaceutical product, medication possession ratio, the number and/or name of doctors from which the patient has received scripts, the number and/or name of retail outlets from which the patient has purchased pharmaceutical products, and/or information regarding the payment method(s) used by the patient when purchasing pharmaceutical products (e.g., cash or insurance).

The prescriber data 128 received from the prescriber system 106, may include any information related to prescriptions written by an identified prescriber for one or more types of pharmaceutical products and the patients to whom the prescriptions were written. Prescriber data 128 may include the quantity of one or more types of pharmaceutical products for which the prescriber has written a prescription, the percentage of prescriptions for one or more types of pharmaceutical products written by a prescriber in relation to the total number prescriptions written by the prescriber, the percentage of prescriptions for one or more types of pharmaceutical products that are paid for with cash, and/or the number of patients for whom the prescriber has written a prescription for one or more types of pharmaceutical products and who currently have a supply of the one or more types of pharmaceutical products that exceeds a threshold. Prescriber data 128 may also include information about which corporate parent the prescriber is related to if any.

The corporate parent data 130 may include information related to the prescribers, physicians, hospitals, clinics or medical group practices owned or managed by one or more corporate parents. For example, the corporate data 130 may include the quantity of one or more types of pharmaceutical products prescribed by an identified physician under the influence of a corporate parent.

The statistical analysis module 120 uses the patient data 126, prescriber data 128 and/or corporate parent data 130 to rate and rank individual patients, prescribers, and corporate parents. In some implementations, statistical analysis module 120 may compare one or more elements of the patient data 126 corresponding to a patient to averages of the one or more elements of the patient data 126 across a set of patients. Based on the comparison of the one or more elements of the patient data 126, the statistical analysis module 120 may assign one or more ratings to a patient. In other words, for each element of the patient data 126 (e.g., quantity of each type of pharmaceutical product the patient has purchased and percentage of purchases that were made with cash), the statistical analysis module 120 may assign a rating to a patient that reflects how an element of the patient data 126 compares to that same element of other patients in a set with respect to these calculated statistics. Patients in the set used in the comparison may be patients in the same location (e.g., country, state, city, or zip code), patients who share similar patient data (e.g., medical diagnosis or demographic information), and/or patients who share some other relationship.

Similarly, the statistical analysis module 120 may compare one or more elements of the prescriber data 128 corresponding to a prescriber to averages of the one or more elements of the prescriber data 128 across a set of related prescribers. Based on the comparison of the one or more elements of the prescriber data 128, the statistical analysis module 120 may assign one or more ratings to a prescriber. Prescribers in the set used in the comparison may be prescribers in the same location (e.g., country, state, city, or zip code), prescribers who share similar professional data (e.g., practice area or demographic information), and/or prescribers who share some other relationship. The statistical analysis module 120 may be able to derive conclusions for prescribers from the prescriber data 128, in a manner similar to that used for the patient data. For example, it may determine that general practitioners in one county tend to prescribe generic drugs with patients with epilepsy, while neurologists are more likely to use branded drugs for their patients with a similar diagnosis. These determinations may, for example, be used to suggest that a pharmaceutical company should promote a new anticonvulsant more heavily to neurologists than to general practitioners.

The statistical analysis module 120 may also compare one or more elements of the corporate parent data 130 corresponding to an corporate parent to averages of the one or more elements of the corporate parent data 130 across a set of related corporate parent outlets. Based on the comparison of the one or more elements of the corporate parent data 130, the statistical analysis module 120 may assign one or more ratings to an corporate parents. Retail outlets in the set used in the comparison may be retail outlets in the same location (e.g., country, state, city, or zip code), prescribers who share similar commercial data (e.g., size of the retail outlet), and/or prescribers who share some other relationship. For example, the data may indicate that certain drugs are more often bought at rural pharmacies, and other drugs are bought at urban pharmacies. For example, these determinations may suggest that pharmacies should stock more antihistamines for pollen allergies at their rural branches.

The statistical analysis module 120 may also compare one or more elements of payer data. The payer data may include information related to the tier structure and co-pay benefits designs of one or more managed care organization. The statistical analysis module may classify an MCO as being advantaged, disadvantaged or parity, using the accessed data. The statistical analysis module may evaluate the interactive influence of the one or more corporate parents and one or more managed care organizations on the prescribing behavior of one or more physicians. In some implementations, the statistical analysis module may use a hierarchical linear model to quantify the interactive effects between the corporate parents and managed care organization influencing a prescriber. The model uses covariates such as specialty and market deciles, calculated by the statistical analysis module based on prescription data, longitudinal prescription data, reference prescriber data, pharmaceutical purchase data and payer data and/or any other combination of data received by the computing systems at the analytical infrastructure. The statistical analysis module may use the equations below to model the share of market (SoM) on managed care organization (MCO) relative access for the pharmaceutical product of interest, using covariates such as specially and market deciles:

SoMᵢₚ=β₀ᵢ+β₁ᵢ·Accₚ+β₂ᵢ·Specᵢ+β₃ᵢ·Decᵢ+eᵢₚ (1)

βki=γk0+ukJ iεJ, k=0,1, . . . 3 (2)

u_{kJ}˜N(0,σ²ₖ) (3)

where i index over prescribers, J index over corporate parents, and p index over MCO plans. Accₚε{Adv, Par, Dis} is the products formulary access on plan p. Specᵢ and Decᵢ are prescriber i's specialty group and market decile respectively.

In some implementations, the statistical analysis module may use any appropriate equation to quantify the interactive effects between corporate parents and managed care organizations. In some implementations, the statistical analysis module may use the hierarchical linear model to quantify the interactive effects between the corporate parents and managed care organization influencing a prescriber based on a specific geographical location. For example, the interactive effects between the corporate parents and managed care organization may be quantified for a state, or group of states or zip codes or group of zip codes. In some implementations, the interactive effects between the corporate parents and managed care organization can may be calculated nationwide.

In some implementations, the statistical analysis module 120 may calculate other metrics. For example, that statistical analysis module may calculate the potential decrease in market size with a change in payer structure of the MCO. For example, the statistical analysis module may calculate that there may be a limit in market size by 75% if, for a specific geographical area, where most of the residence are supported under a tier three coverage program (that is designed to cater to low income residence) if there were to be an introduction of a tier one coverage plan.

The reporting module 122 prepares reports based on the ratings and/or rankings and interactive influences calculated by the statistical analysis module 120. The reports prepared by the reporting module 122 may include one or more of the ratings calculated by the statistical analysis module 120 as well as any other data contained in the patient data 126, prescriber data 128 and/or corporate parent data 130. For example, a report generated by the reporting system may include composite ratings for all prescribers in a given state for a particular pharmaceutical product (e.g., oxycodone—a controlled substance). The reporting module 122 may prepare reports based on the interactive influences of corporate parents and managed care organizations on retail prescribing behavior. The reporting module may prepare reports that compare the change in interactive influences over time. For example, a report may depict the increase influence of a specific corporate parent in a specific geographic area in the last quarter.

The system shown may be filtered and/or mined based on any one or more criteria associated with a patient, prescriber, and/or retail outlet. The reports may be filtered and/or mined based on location, type pharmaceutical product, medical specialty of a prescriber, category of a retail outlet (e.g., large chain retail outlet), and or one or more ratings calculated by the statistical analysis module 120. In other words, any data received and processed by the data processing module 118 or any ratings or rankings calculated by the statistical analysis module 120 may be included in or used to filter and/or mine the data included in a report.

Additionally, in some implementations, the reports generated may be either dynamic or static. The reporting module 122 may generate a report that includes data presented in one or more static formats (e.g., a chart, a graph, or a table) without providing any mechanism for altering the format and/or manipulating the data presented in the report. In such an implementation, the data presentation is generated and saved without incorporating functionality to update the data presentation. In some implementations, the reporting module 122 provides a static report in a PDF, spreadsheet, or XML format. Such a format generally provides an understanding of the reporting module 122 as textual data or a visualization, but other forms of presenting conclusions such as audio, video, or an animation are not excluded as potential results from reporting module 122.

Additionally or alternatively, the reporting module 122 may generate a report that includes controls allowing a user to alter and/or manipulate the report itself interactively. For example, the reporting system may provide a dynamic report in the form of an HTML document that itself includes controls for filtering, manipulating, and/or ordering the data displayed in the report. Moreover, a dynamic report may include the capability of switching between numerous visual representations of the information included in the dynamic report. In some implementations, a dynamic report may provide direct access as selected by a user to some or all of the patient data 126, prescriber data 128 and/or outlet data 130 prepared by the data processing module 118 and/or the statistical analysis module 120, as opposed to allowing access to only data and/or ratings included in the report itself.

One or more clients 140 may interface with the computing system 100 to request and receive reports created by the reporting system. In some implementations, the one or more clients 140 may include a web browser that provides Internet-based access to the computing system 100. Through the web browser, a user of a client 140 (e.g., a wholesaler, a retail outlet, or a prescriber) may request a static or dynamic report from the reporting system as discussed above.

There may be any number of clients 140 associated with, or external to, the example computing system 100. While the illustrated example computing system 100 is shown in communication with one client 140, alternative implementations of the example computing system 100 may communicate with any number of clients 140 suitable to the purposes of the example computing system 100. Further, the term “client” and “user” may be used interchangeably as appropriate without departing from the scope of this disclosure. Moreover, while the client 140 is described in terms of being used by a single user, this disclosure contemplates that many users may share the use of one computer, or that one user may use multiple computers.

The illustrated client 140 is intended to encompass computing devices such as a desktop computer, laptop/notebook computer, wireless data port, smartphone, personal digital assistant (PDA), tablet computing device, one or more processors within these devices, or any other suitable processing device. For example, the client 140 may include a computer that includes an input device, such as a keypad, touch screen, or other device that can accept user information, and an output device that conveys information associated with the operation of the computing system 100. The input device may be used by client 140 to provide instructions to computing system 100 that computing system 100 can execute to provide information requested by client 140 from the various data that computing system 100 receives.

In some implementations, functionality described as being performed by the computing system 100 may be performed by the client 140. For example, the computing system 100 may provide a client 140 with direct access to the ratings and rankings calculated by the statistical analysis module 120. As a result, some or all of the functionality described as being performed by the reporting module 122 may be performed locally by the client 140. The analytical infrastructure may be supported on a webpage application that a client may use to view the data received by the computing system at the analytic infrastructure.

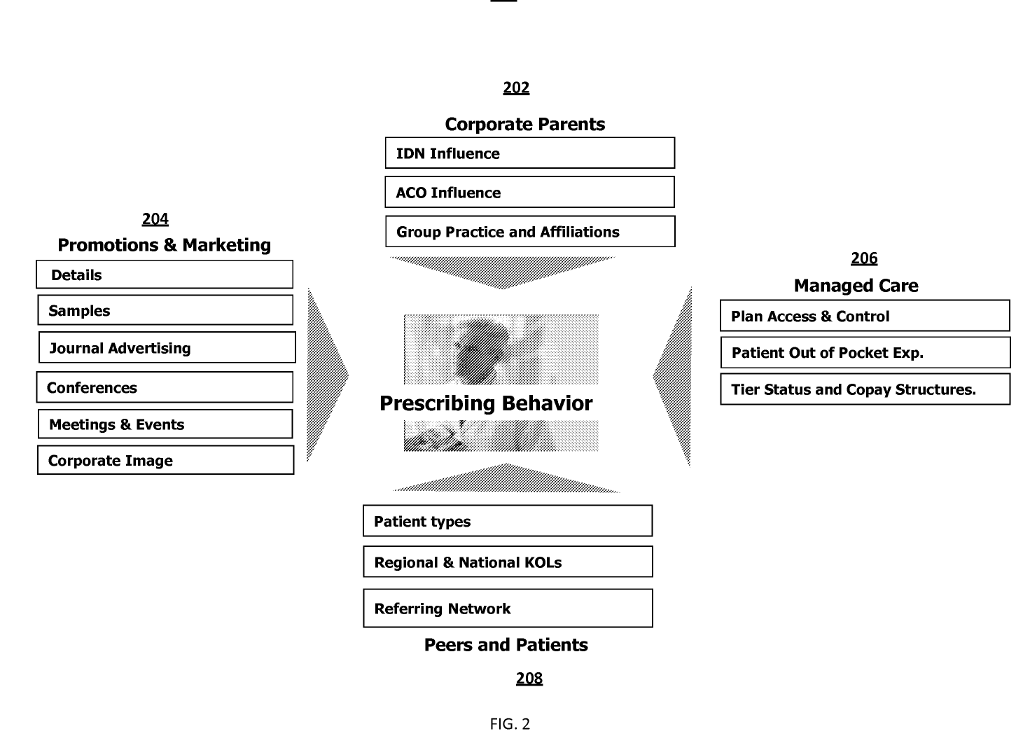

FIG. 2 illustrates the various actors involved in affecting the prescribing behavior of a physician. Several various factors may affect the treatment choice selected by the prescriber as illustrated in FIG. 2. Peers and patients 208 may affect prescribing behavior, and have recently begun to have an increase in influence on the selection of prescription choice through self-advocacy and awareness of health conditions and available treatments. The increase in awareness by patients has occurred though electronic and social media, and also due to direct to consumer advertising from manufacturer. There has also been an increase in the number of patient advocacy organizations that help make patients aware of treatment choices and help to increase the influence of patients on treatment choice. The prescribing behavior of a prescriber may also be affected by his/her peers. The prescriber's peers may have been introduced to a new drug and share the information with his or her colleague.

Managed care organizations (MCOs) 206 may also influence the treatment choice provided to a patient by the prescriber. Managed care is the term used to describe a variety of techniques intended to reduce the cost of providing health benefits and improve the quality of care for patients. Organizations that practice these techniques, and/or provide these techniques as services to other organizations are described as managed care organizations. There are several different types of managed care organizations, each vary in structure and restrictiveness. Managed care organizations may set guidelines for pharmaceutical drug coverage that is offered to the patients under the MCO. Managed care organizations also have tier structures and copay structures. For example, some preferred provider organizations (PPO), patients do not have a co-pay. Some MCO may have one or more tier structure, where cost of pharmaceutical products and cost of services may be different for each tier structure.

The influence of managed care organizations is on the rise due to health care reform. For example, the Patient Protection and Affordable Care Act (PPACA) has expanded health care coverage to millions, who were previously uninsured. This reform of health care has increased the pressure on the health care industry to reduce the cost of health care. Growing payer influence may also affect treatment choice selected by prescribers. Payers, such as insurance companies and in the case of patients on Medicaid, the government, specify a list of prescription drugs that will be covered by different heath care plans. The influence of the insurance companies may grow increasingly as insurance companies decrease the selection of prescription drugs that may be covered by ones' health care plan. Both government and private payers have an effect on treatment choice by pressuring physicians to prescribe affordable treatment choices.

Promotions and marketing 204 may also have an impact on prescribing behavior. Pharmaceutical companies may be one of the huge contributors to promoting and marketing pharmaceutical products. These companies may in turn have a large impact on the selection of treatment choice. Pharmaceutical companies, in the past, have focused sales and marketing tactics solely on physicians and may even provide physicians with free samples to promote the use of a particular drug. Extensive marketing of a product by a pharmaceutical company to physicians may lead the physician to be persuaded by the sales tactics. Pharmaceutical companies may even provide free samples to prescribers. The pharmaceutical company may require the prescriber tracks the number of distributed free samples and the number of patients that use the prescribed drug after receiving a free sample. Tracking free samples may include, the prescriber providing the patient with a voucher card that the patient may use to register online to receive the free sample from a pharmacy. In some cases, corporate parents uphold strict restrictions that restrict pharmaceutical companies from even providing free samples to physicians within corporate parent. Additionally, the introduction of a variety of new promotional channels into the marketing world has led to challenges within the marketing strategies of pharmaceutical companies. For example, the introduction of social media has allowed pharmaceutical companies with smaller marketing budgets to advertise pharmaceutical products for far less than other traditional marketing strategies. Medical conferences and journal advertising may also influence prescribing behavior.

Corporate parents 210 may also affect the treatment choice for a patient. A corporate parent is a legal entity that owns, manages, leases, or affiliates purely for purchasing care providing entities, including medical group practice, clinics, and hospital. An integrated delivery network (IDN) is a special type of corporate parent that consists of a network of facilities and providers that work together to offer a continuum of care to a specific geographic area or market and is type of managed care organization. The providers within an IDN may offer discounted rates to members within the IDN. An IDN may have a large impact on the treatment choice selected by the physician since treatment choice would most likely be a product provided by the internal pharmacy services. In the United States, the government has many state laws that are meant to promote the development of IDNs to ensure the quality of care delivered to patients. This promotion of the development of IDNs has led to an increase in the number of IDNs across the nation exceeds 900. IDNs have implemented strict treatment protocols that set strict guidelines to the physicians within an IDN on which drugs and treatments are preferred for which conditions. The IDNs may also require evidence of the effectiveness of a specific drug and the overall cost effectiveness before the drug may be approved to be prescribed to patients within the IDN.

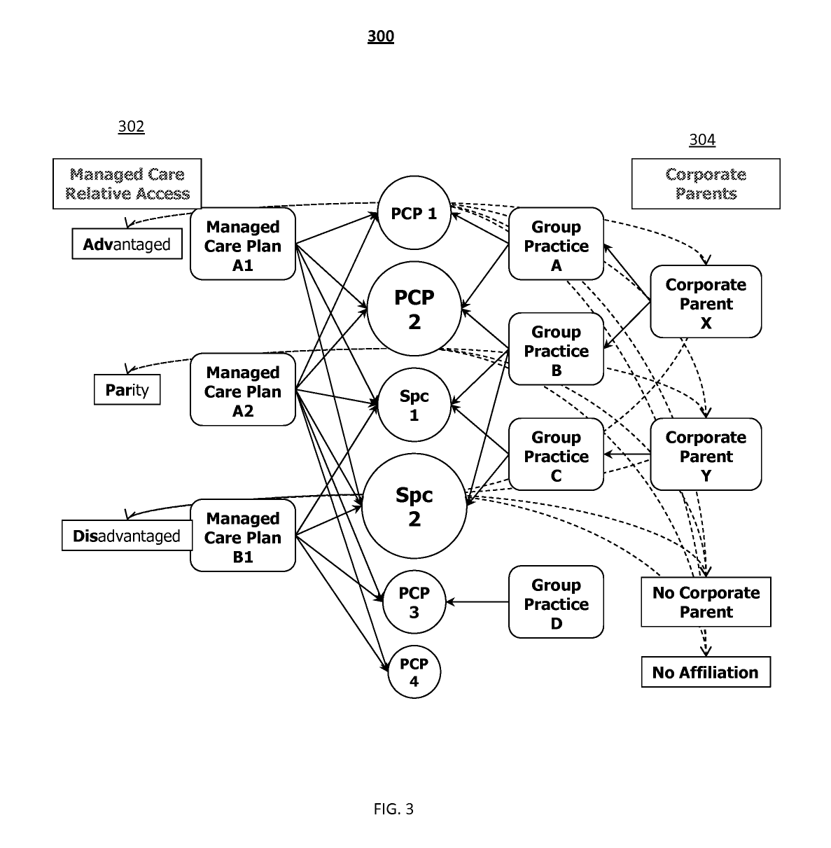

FIG. 3 illustrates the interactions of one or more managed care plans and corporate parents. As illustrated in FIG. 3, the effects of managed care relative access are not the same across corporate parents. The computing systems at the analytical infrastructure may use accessed prescription data, longitudinal prescription data, reference prescriber data, pharmaceutical purchase data and payer data to classify managed care access as advantaged, parity or disadvantaged. The computing systems at the analytical infrastructure may classify the individual tiers within a managed care plan. For example, the tier 1 plan of managed care plan A1 may be determined to be advantaged, whereas the tier 3 plan of managed care plan A1 may be determined to be parity, based on the accessed data. The computing systems at the analytical infrastructure may also use accessed IMS Rx data. IMS Rx data may include market deciles data and share of market data. As displayed in FIG. 3, a corporate parent may affect one or more practice groups. A practice group also may not be affiliated with a corporate parent at all, and may just be influenced by managed care access. In some instances, a corporate parent may influence one practice group more so than another practice group. The computing systems at the analytical infrastructure can determine on a granular level, for a specific geographical area, the influence of the managed care access and the influence of the corporate parent on the prescribing behavior of prescribers within the geographical area.

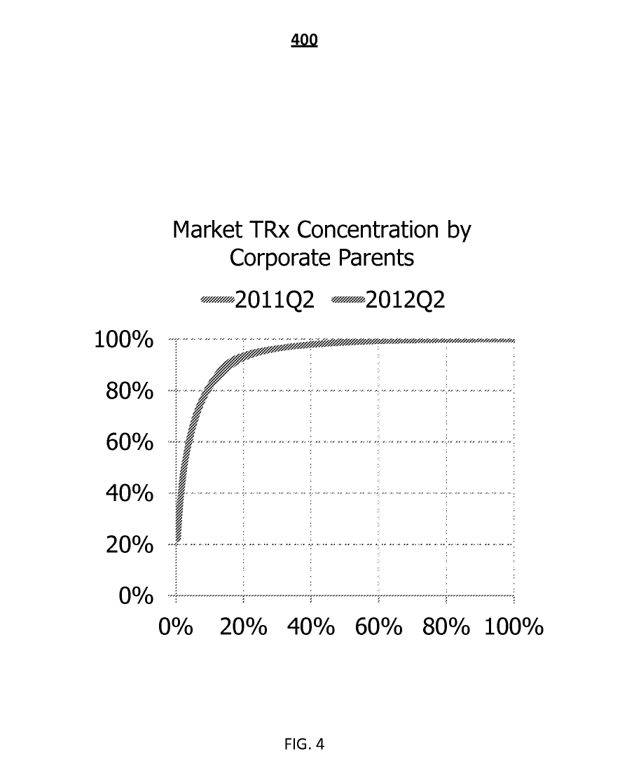

FIG. 4 illustrates an example graphical representation of market share concentration among corporate parents. The data represents the changes in market TRx concentration for two quarters. The data displays the steady increased in the market concentration by corporate parents in both quarters.

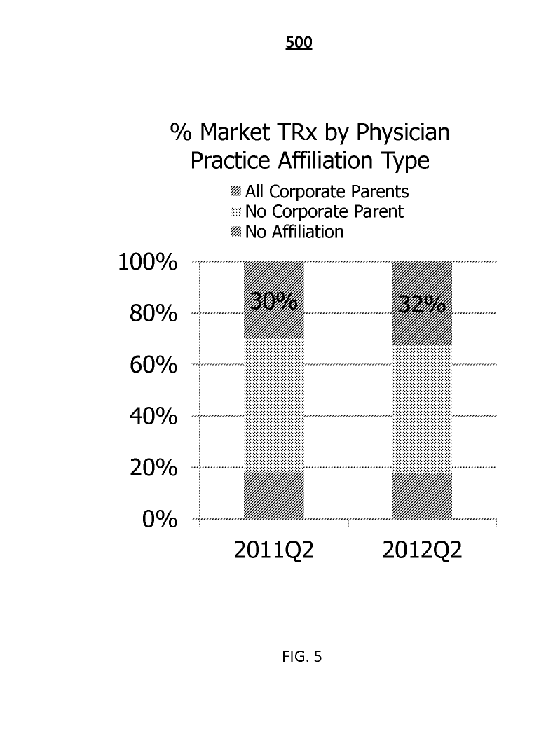

FIG. 5 illustrates an example graphical representation of market TRx by physician affiliation. The data represents the affiliation of physicians for two quarters. As illustrated, there was increase of the percentage of physicians affiliated with a corporate parent, from 30% to 32%.

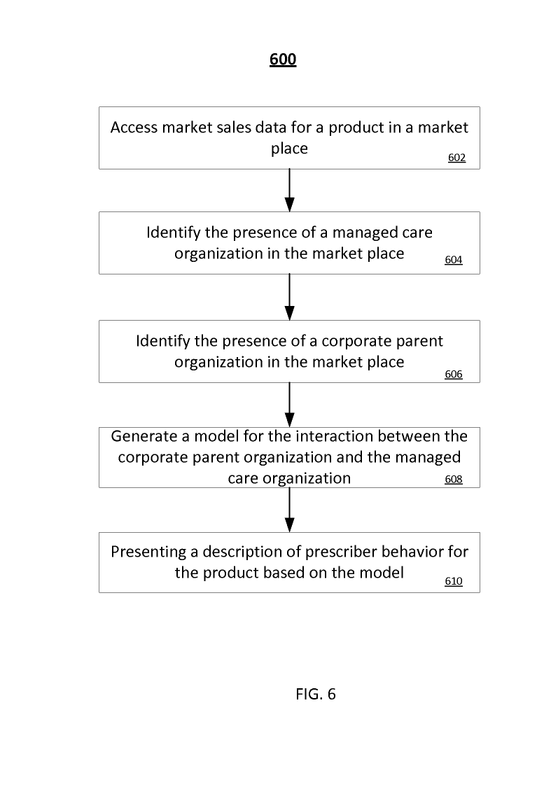

FIG. 6 is a flow chart of a process by which the analytic infrastructure uses accessed market sales data to generate a model for the interaction between the corporate parent organization and managed care organization.

The analytical infrastructure accesses historical marketing data related to sales of a particular pharmaceutical product (602). The computing systems at the analytic infrastructure may access marketing information from the pharmaceutical company that manufactures and distributes a particular product. The marketing information may include information on the number of free samples of the product distributed to physicians and the number of coupons or vouchers for the product distributed to physicians. The information reported to the analytic infrastructure may also include the revenue spent on calling physicians to market product and the revenue spend on hosting online broadcast marketing the product to physicians. The pharmaceutical company may report all the marketing data related to a product to the analytical infrastructure system periodically, for example the pharmaceutical company may report data once a week, or the pharmaceutical company may report once a month. In some implementations, the computing systems at the analytic infrastructure may requests marketing data from the pharmaceutical company for a specified time period. The analytical infrastructure may request information on marketing a product in a specified geographic location. The computing systems at the analytic infrastructure may save the marketing data related to the sales of the product. The analytical infrastructure may also access IMS RX data.

The analytical infrastructure identifies the presence of a managed care organization in the market place (604). The data reported from the pharmaceutical company on the sales of a product in a geographical area may include a physician identifier. The physician identifier identifies the physician that prescribed the product. The physician identifier may be used by the analytic infrastructure to identify the managed care organization the prescriber who prescribed the product is related to. The information may further include a network identifier, the network identifier identifies the corporate parent. In some implementations, the analytical infrastructure may identify a geographical area and identify the active corporate parents within the geographical area. In some implementations, one or more corporate parents may be identified in the accessed historical marketing data

The analytical infrastructure identifies the presence of a corporate parent in the market place (606). The data reported from the pharmaceutical company may include a physician identifier or network identifier. The physician identifier may identify the physician that prescribed the pharmaceutical product. The physician identifier may be used by the analytical infrastructure to identify the corporate parent the prescriber who prescribed the product is related to, if any. The information may further include a network identifier, the network identifier identifies the corporate parent. In some implementations, the analytical infrastructure may identify a geographical area and identify the active corporate parents within the geographical area. In some implementations, one or more corporate parents may be identified in the accessed historical marketing data.

The analytical infrastructure generates a model for the interaction between the corporate parent organization and the managed care organization (608). The data processing module 118 at the analytic infrastructure computing system processes the accessed historical marketing data. In processing the data, the data processing module may filter and/or mine the marketing data for specific information. The data processing module may filter/or mine the marketing data for data on a specific pharmaceutical product. The data processing module may filter/or mine marketing information for data from the identified corporate parent and the identified managed care organization. The statistical analysis module may use the processed data for a specific pharmaceutical product and a specific corporate parent and specific managed care organization to model the interaction between the corporate organization and managed care organization. In some implementations, the statistical analysis module may use a hierarchical linear model to quantify the interactive effects between the corporate parents and managed care organization influencing a prescriber. The model uses covariates such as specialty and market deciles, calculated by the statistical analysis module based on prescription data, longitudinal prescription data, reference prescriber data, pharmaceutical purchase data and payer data and/or any other combination of data received by the computing systems at the analytical infrastructure. The statistical analysis module may use the equations below to model the share of market (SoM) on managed care organization (MCO) relative access for the pharmaceutical product of interest, using covariates such as specially and market deciles:

SoMᵢₚ=β₀ᵢ+β₁ᵢ·Accₚ+β₂ᵢ·Specᵢ+β₃ᵢ·Decᵢ+eᵢₚ (1)

βki=γk0+ukJ iεJ, k=0,1, . . . 3 (2)

u_{kJ}˜N(0,σ²ₖ) (3)

where i index over prescribers, J index over corporate parents, and p index over MCO plans. Accₚε{Adv, Par, Dis} is the products formulary access on plan p. Specᵢ and Decᵢ are prescriber i's specialty group and market decile respectively.

The analytic infrastructure presents a description of prescriber behavior for the product based on the model (610). In some implementations, the analytic infrastructure presents a display that includes, for a given geographical area, the prescribers influenced by the corporate parent and the managed care organization. The display may also include the relative strength of the influence of the corporate parent and managed care on each prescriber. For example, the display may indicate that the corporate parent, Advocate Health care has an influence of 23.5% and the managed care organization has an influence of 10.3% on prescriber Henry Clarke. In some implementations, the display may indicate the prescribers that are not influenced by either a corporate parent or managed care organization.

In some implementations, the analytical infrastructure may present a marketing investment based on the model of the interactive of the corporate parent and managed care organization. The marketing investment may identify targeting marketing strategies towards management of the corporate parent. For example, coordinating sales programs, managed market strategies and key account management strategies in a specified geographical area.

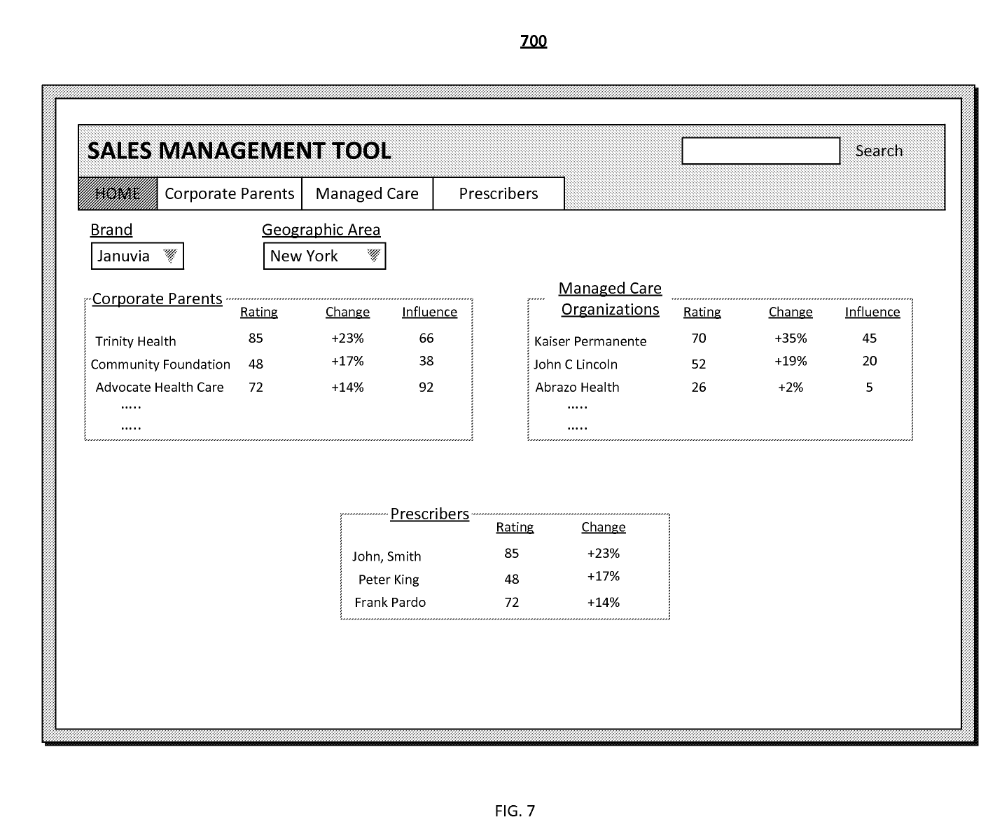

FIG. 7 illustrates an example user interface 700 of a web application for a sales management tool. Interface 700 may be displayed when a user, at a pharmaceutical company logs into a secure connection with the sales management tool system. The user may log into the sales management tool system by providing a user specific user name and password. The web page may be specific to individual users of the sales management tool system, that is, the webpage generated is specific to pharmaceutical company. In some implementations, the user may have the option to customize the information displayed on the web page. In these implementations, the web page may include a “Customize Page” tab displayed on the home page.

The web page may include one or more drop down tabs. The drop down tabs may be used to specify a brand, and a geographical area. A brand may be a particular pharmaceutical drug manufactured/distributed by the pharmaceutical company. The geographical area may be specified by state, county or zip code. For the example illustrated in FIG. 7, historical data is displayed for the selected brand Januvia, within the New York geographic area. As illustrated in FIG. 7, the web page may list the top corporate parents and managed care organizations (MCOs) that are present in the selected geographic area. The webpage may also display the prescribers within the geographical area. In some implementations, the user may specify a threshold influence value that must be met for corporate parents listed on the user's webpage when a specific product and geographical area is selected. For example, a user may set his/her threshold value to 10%, in this example, only corporate parents that have at least 10% influence on prescribing behavior of a particular product within the specified geographic area would be display in the list of corporate parents. In some implementations, the user may specify a threshold influence value that must be met for any MCO listed on the user's webpage when a specific product and geographic area is selected. In other implementations, the computing systems at the analytical infrastructure display any corporate parent and any MCO that affects the prescribing behavior of at least one prescriber for the selected product in the selected geographic area.

The data displayed may be computed by the statistical analysis module at the computing systems of the analytical infrastructure, from the prescription data, payer data, pharmaceutical purchase data, longitudinal prescription data and IMS Rx data. The corporate parent and/or MCO rating may be calculated based on all or some of the data collected for a specific geographical area or may be based on a nationwide rating. In some implementations, the web page may display, for each prescriber in the selected geographic area, the influence of the corporate and/or managed care organization. In some implementations, the data may display in the form of a graph or a chart.

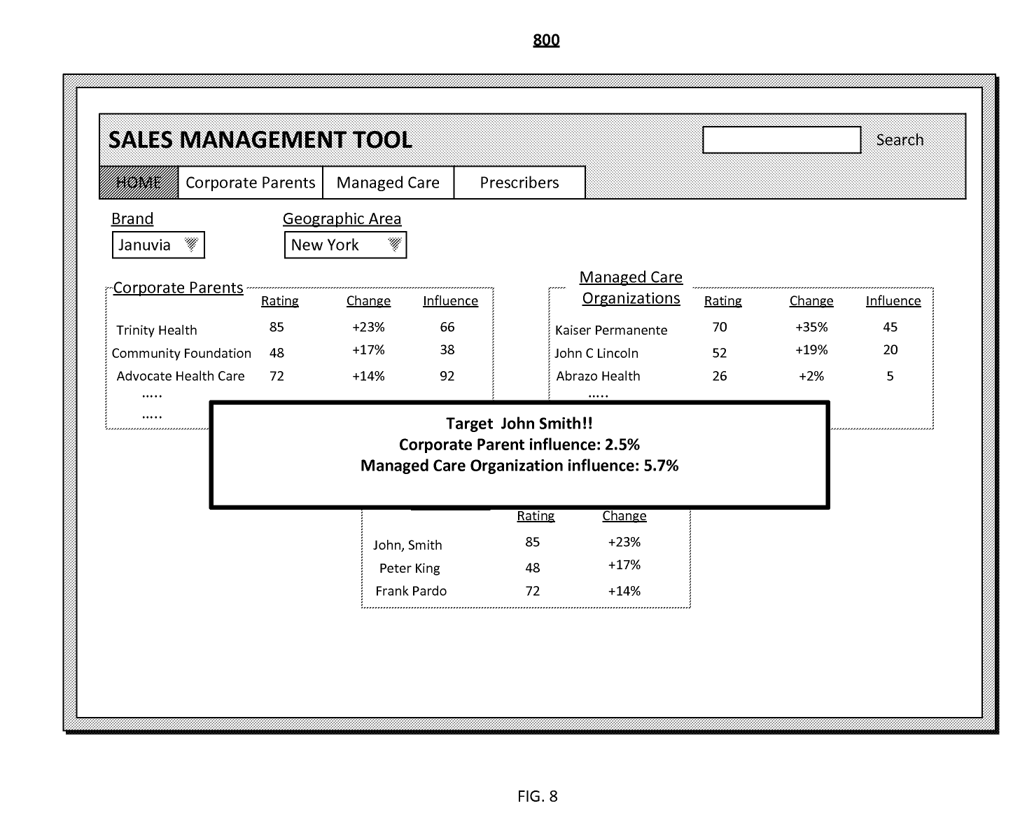

FIG. 8 illustrates an example user interface 800 of a web application for a sales management tool. Interface may be displayed when a user at a pharmaceutical company logs into a secure connection with the sales management tool system. The user may log into the sales management tool system by providing a user specific user name and password. The web page may be specific to individual users of the sales management tool system, that is, the webpage generated is specific to pharmaceutical company.

The web page may include one or more drop down tabs. The drop down tabs may be used to specify a brand, and a geographical area. A brand may be a particular pharmaceutical drug manufactured/distributed by the pharmaceutical company. The geographical area may be specified by state, county or zip code. For the example illustrated in FIG. 8, the computing systems at the analytical infrastructure may generate an alert. The alert may indicate the prescriber within a corporate parent that may be targeted based on the relative influence of the corporate parent and the MCO. As illustrated in FIG. 8, the alert indicates that for the prescriber John Smith, the corporate parent influence is 2.5%, and the MCO influence is 5.7%, for the product Januvia. The computing systems at the analytical infrastructure may determine that market share of the particular product may be increased if sales forces target prescriber John Smith. This may be the case where the specified product is supported by the tier structure of the MCO that exerts influence on prescriber John Smith. The computing systems at the analytical infrastructure may identify whether the MCO exerting influence on the identified target prescriber is categorized as advantaged, disadvantaged or parity. In some implementations, the computing systems at the analytical infrastructure may display the categorization of each MCO displayed for a specified geographical area and specified product.

In some other implementations, the alert generated may identify independent prescribers in the specified geographical. Independent prescribers may be prescribers that are not associated with a corporate parent and/or MCO. Prescribers identified as independent may be targeted by the sales force, since prescribing behavior of independent prescribers are not influenced by MCO structures and corporate parent rules and regulations. In some implementations, prescribers may be identified as independent if the corporate parent influence and/or managed care organization influence is below a predetermined minimum. For example, prescribers with a corporate parent and or MCO influence below 10%, may be identified as independent.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

Pharmaceuticals in various implementations need not necessarily be heavily controlled, and the methods presented herein equally apply to over-the-counter drugs or even potentially to herbal preparations or nutritional supplements that have the potential to have an impact on medical treatment. The use of St. John's Wort to treat a patient with clinical depression may be considered by an implementation, as may a nutritional supplement such as fish oil or a prescription antidepressant.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method comprising:
accessing market sales data for a product in a market place;
identifying the presence of a managed care organization in the market place;
identifying the presence of a corporate parent organization in the market place;
generating a model for the interaction between the corporate parent organization and the managed care organization;
presenting a description of prescriber behavior for the product based on the model.

2. The computer-implemented method of claim 1 wherein the identified corporate parent is an Integrated Delivery Network (IDN).

3. The computer-implemented method of claim 1 wherein identifying a presence of a managed care organization in a market place comprising identifying a presence of the managed care organization in a specific geographic region.

4. The computer-implemented method of claim 1 wherein identifying a presence of a corporate parent in a market place comprising identifying a presence of the corporate in a specific geographic region.

5. The computer-implemented method of claim 1 wherein identifying the presence of a managed care organization comprises identifying one or more managed care organizations in the market place.

6. The computer-implemented method of claim 1 wherein presenting a description of prescriber behavior for the product based on the model comprises presenting a description of the prescriber behavior in a pop up window on a user interface.

7. A system comprising:
one or more computers and one or more storage devices storing instructions that are operable, when executed by one or more computers, to cause the one or more computers to perform operations comprising:
accessing market sales data for a product in a market place;
identifying the presence of a managed care organization in the market place;
identifying the presence of a corporate parent organization in the market place;
generating a model for the interaction between the corporate parent organization and the managed care organization;
presenting a description of prescriber behavior for the product based on the model.

8. The system of claim 7 wherein the identified corporate parent is an Integrated Delivery Network (IDN).

9. The system of claim 7 wherein identifying a presence of a managed care organization in a market place comprising identifying a presence of the managed care organization in a specific geographic region.

10. The system of claim 7 wherein identifying a presence of a corporate parent in a market place comprising identifying a presence of the corporate in a specific geographic region.

11. The system method of claim 7 wherein identifying the presence of a managed care organization comprises identifying one or more managed care organizations in the market place.

12. The system of claim 7 wherein presenting a description of prescriber behavior for the product based on the model comprises presenting a description of the prescriber behavior in a pop up window on a user interface.

13. A non-transitory computer-readable medium storing software comprising instructions executable by one or more which, upon such execution, cause the one or more computers to perform operations comprising:
accessing market sales data for a product in a market place;
identifying the presence of a managed care organization in the market place;
identifying the presence of a corporate parent organization in the market place;
generating a model for the interaction between the corporate parent organization and the managed care organization;
presenting a description of prescriber behavior for the product based on the model.

14. The medium of claim 13 wherein the identified corporate parent is an Integrated Delivery Network (IDN).

15. The medium of claim 13 wherein identifying a presence of a managed care organization in a market place comprising identifying a presence of the managed care organization in a specific geographic region.

16. The medium of claim 13 wherein identifying a presence of a corporate parent in a market place comprising identifying a presence of the corporate in a specific geographic region.

17. The medium of claim 13 wherein identifying the presence of a managed care organization comprises identifying one or more managed care organizations in the market place.

18. The medium of claim 13 wherein presenting a description of prescriber behavior for the product based on the model comprises presenting a description of the prescriber behavior in a pop up window on a user interface.
